(19) United States
(12) Patent Application Publication
(10) Pub. No.: US 2011/0317154 A1
(43) Pub. Date: Dec. 29, 2011

(54) SYSTEMS AND METHODS FOR DETERMINING COORDINATE LOCATIONS OF SENSOR NODES OF A SENSOR NETWORK

(76) Inventors: Michael Renne Ty Tan, Menlo Park, CA (US); Peter George Hartwell, Sunnyvale, CA (US)

(21) Appl. No.: 12/822,335

(22) Filed: Jun. 24, 2010

(51) Int. Cl. G01B 11/26

(52) U.S. Cl. 356/139.03

(57) ABSTRACT

Various embodiments of the present invention are directed to systems and methods for determining coordinate locations of sensor nodes of a sensor network. In one aspect, a method determines three-dimensional coordinates of a reference location in a terrain over which the sensor network is deployed. Beginning with the reference location, the method tracks the movement of an optical sensor as the optical sensor moves to each sensor node in series and determines a three-dimensional coordinate of each sensor node relative to the reference location based on data collected by the optical sensor. The method also programs the three-dimensional coordinate into each sensor node.

### TECHNICAL FIELD

Embodiments of the present invention relate to sensor networks.

### BACKGROUND

A typical sensor network is composed of spatially distributed autonomous sensor nodes that each measure physical and/or environmental conditions, such as temperature, sound, vibration, pressure, motion, or pollutants, and relay the measurement information to a central processing or data storage node. Sensor networks are used to monitor conditions in a wide variety of industrial and environmental settings and have traditionally been implemented using either electrical wires or wireless transmission for relaying the measurement results. With wired sensor networks, each wire electronically connects one or more sensor nodes to the central processing node. Each wired sensor node includes, in addition to sensors and a microcontroller, an energy source such as a battery. With wireless sensor networks, each sensor node can communicate with the central processing node using a separate radio frequency. Each wireless sensor node includes, in addition to sensors, a radio transceiver or other wireless communication devices, a microcontroller, and an energy source.

A grid of sensor nodes typically has to be deployed with accurate three-dimensional coordinate locations, such as longitude, latitude, and elevation, for each sensor node. FIG. 1 shows a landscape view of a grid of six sensor nodes 101-106 of a sensor network. Each sensor node is located in a different part of the landscape and has a different associated coordinate location. Surveying and differential global positioning are the traditional techniques employed to determine sensor node coordinate locations. Both techniques can provide accurate determination of the three-dimensional coordinate locations of the sensor nodes and the distances and angles between them. However, deploying a grid with a large numbers of sensors nodes over a large range using either surveying or differential global position can be time consuming and cost prohibitive. Users and manufacturers of sensor networks continue to seek systems and methods that can be used to deploy sensor nodes in an accurate, fast and cost effective manner.

### BRIEF DESCRIPTION OF THE DRAWINGS

FIG. 1 shows a landscape view of six sensor nodes of a sensor network.

FIGS. 2A-2B show schematic representations of two optical sensors configured in accordance with one or more embodiments of the present invention.

FIG. 2C shows an example sensor network deployed on a terrain represented by a topographic map in accordance with one or more embodiments of the present invention.

FIGS. 3A-3F show an example series of terrain images captured by an optical sensor as the optical sensor is moved in accordance with one or more embodiments of the present invention.

FIG. 4 shows terrain images associated with a path displayed in three-dimensional space obtained in accordance with embodiments of the present invention.

FIG. 5 shows an example schematic representation of an elevation system configured and operated in accordance with embodiments of the present invention.

FIG. 6 shows a flow diagram summarizing determining coordinate locations of sensor nodes in accordance with one or more embodiments of the present invention.

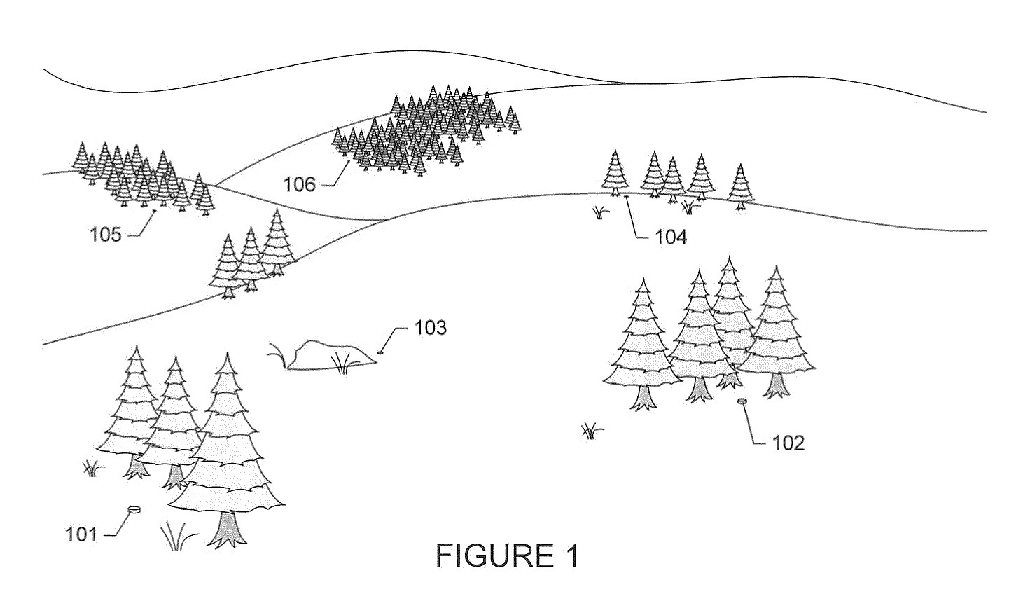

### DETAILED DESCRIPTION

Various embodiments of the present invention are directed to systems and methods for deploying sensor nodes of a sensor network. System embodiments include an optical sensor used to accurately determine distances from each sensor node to a known reference location. Before a grid of sensor nodes is deployed, the optical sensor is used to identify a reference location. The optical sensor is then used to image the terrain as the grid of sensor nodes is deployed. For each sensor node, the optical sensor tracks the movement of a grid layer (e.g., person or vehicle) by capturing overlapping terrain images until the grid layer reaches a location at which a sensor node is to be deployed. The sensor node location with respect to the reference location is determined and programmed into the sensor node.

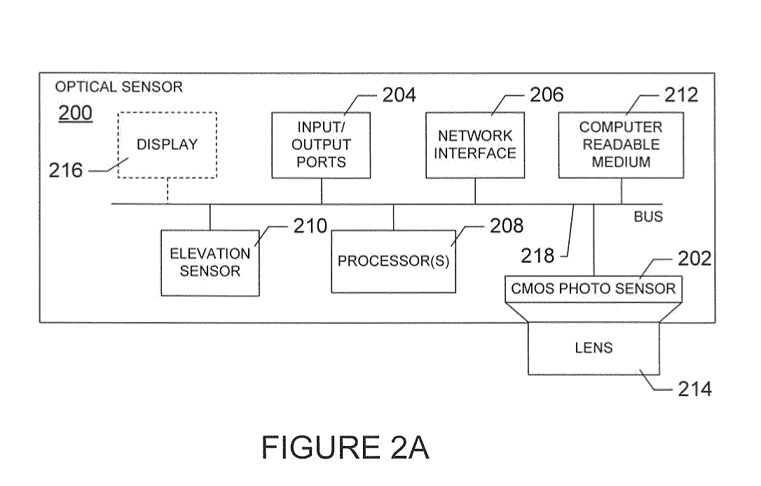

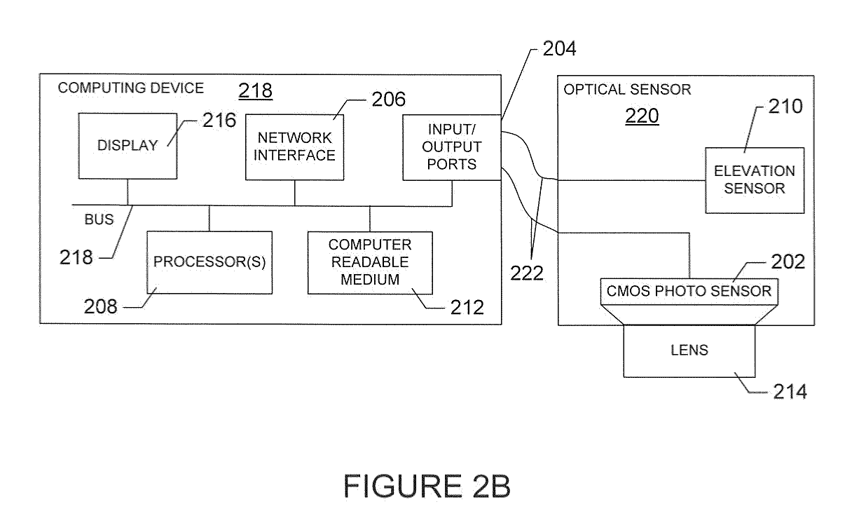

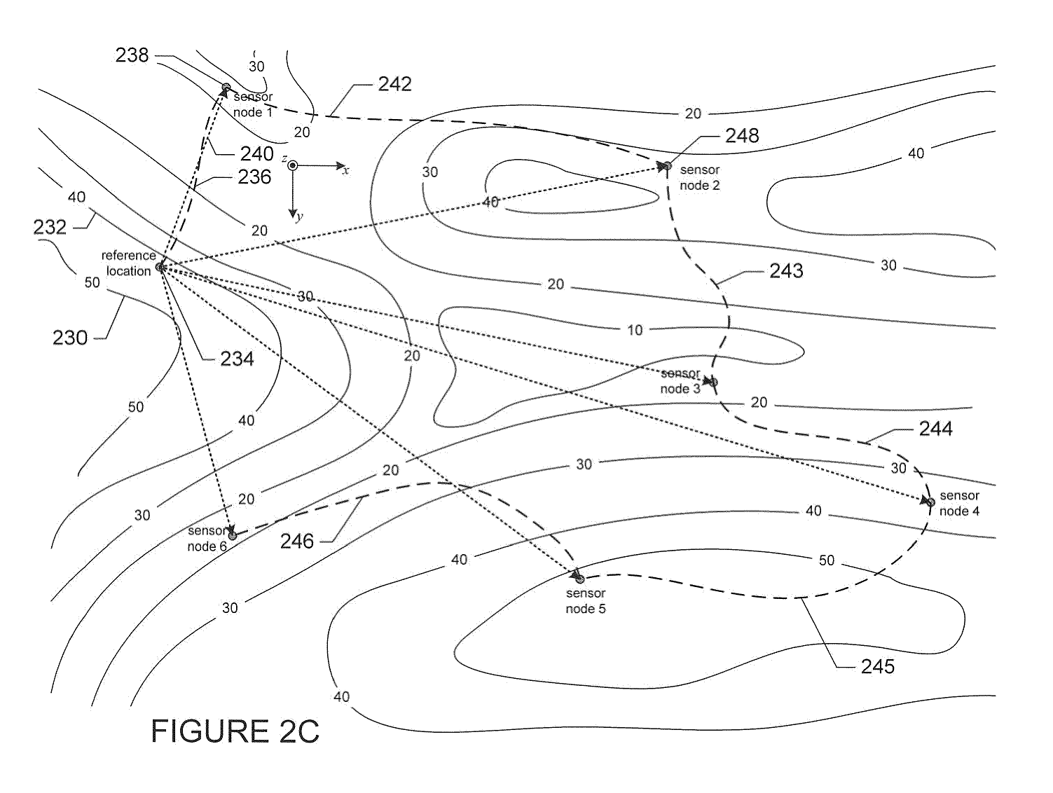

FIG. 2A shows a schematic representation of an optical sensor 200. The optical sensor 200 includes a CMOS photo sensor 202; input/output ports 204, such as USB ports; one or more network interfaces 206, such as a Local Area Network LAN, a wireless 802.11x LAN, a 3G mobile WAN or a WiMax WAN; one or more processors 208; an elevation sensor 210; a computer readable medium 212; and a lens 214 configured to focus images onto a CMOS photo sensor array 214. The optical sensor 200 may optionally include a display 216 for hand held optical sensors, or the display 216 can be mounted in the cab of vehicle. Each of these components is operatively coupled to one or more buses 218. For example, the bus 218 can be an EISA, a PCI, a FireWire, a NuBus, or a PDS.

Images captured by the photo sensor array are transmitted to the processor 206 for image processing. The elevation sensor 208 detects conditions that can be used to determine the elevation of the sensor as terrain images are captured. The optical sensor 200 also includes a computer readable medium 212, which can be any suitable medium that participates in providing instructions to the processor(s) 208 for execution. For example, the computer readable medium 212 can be non-volatile media, such as an optical or a magnetic disk; or volatile media, such as memory. Once the coordinate location of a sensor node has been determined relative to a reference location as described below, the computer readable medium 212 can include light or radio frequency waves to transmit the coordinate location to the sensor node. The computer readable medium 212 can also store other software applications, including global position system applications for identifying the reference location.

The computer-readable medium 212 may also store an operating system, network applications, and an image processing applications. The operating system can be multi-user, multiprocessing, multitasking, multithreading, real-time and the like. The operating system can also perform basic tasks such as recognizing input from input devices, such as a keyboard, a keypad, or a mouse; sending output to the display 216; keeping track of files and directories on the medium 212; controlling peripheral devices, such as disk drives, and printers; and managing traffic on the one or more buses 218. The network applications includes various components for establishing and maintaining network connections, such as software for implementing communication protocols including TCP/IP, HTTP, Ethernet, USB, and FireWire. In certain embodiments, some or all of the processes performed by the applications can be integrated into the operating system. In certain embodiments, the processes can be at least partially implemented in digital electronic circuitry, or in computer hardware, firmware, software, or in any combination thereof.

System embodiments of the present invention are not limited to all of the computation components being implemented in a single optical sensor. FIG. 2B shows a schematic representation of an optical sensor 220 and a computing device 218. The optical sensor 220 includes the lens 214, photo sensor 202, and elevation sensor 210 and can be mounted on the outside of a vehicle used for grid laying. The computing device 218 includes the display 216, network interface 206, input/output ports 204, processor(s) 208, and computer readable medium 212. The computing device 218 can be mounted inside the cab of the vehicle and can be in communication with the optical device 216 via cables 222.

The optical sensors 200 and 220 are operated by pointing the lens 214 at the ground in order to capture images of the terrain as a grid layer moves to a location at which a sensor node is to be deployed. For example, the grid layer can be a vehicle and the optical sensor 200 can be attached to the vehicle bumper or suspended by a boom attached to the vehicle with the lens 214 pointed at the ground. As the vehicle operator drives the vehicle toward a desired location to deploy a sensor node, the optical sensor 200 captures overlapping images of the terrain. The optical sensor 200 can implemented as a hand-held device and the grid layer can be a person. The person holds the optical sensor 200 to capture overlapping images of the terrain as the person walks or hikes toward a desired sensor node location.

FIG. 2C shows an example sensor network deployed on a terrain represented by a topographic map. Topographic maps show topography, or land contours, by means of contour lines, such as contour lines 230 and 232. Contour lines are curves that connect contiguous points of the same elevation. For example, every point on the contour line 230 represents a point in the landscape that is 50 meters in elevation above mean sea level. The sensor network comprises six sensor nodes labeled 1 through 6. The sensor nodes are deployed using the optical sensor 200 or 220 described above by first identifying a reference location 234. The reference location serves as an origin of a three dimensional coordinate system, represented by the three-tuple (0, 0, 0), with each node occupying a point in the coordinate system. The coordinates of each sensor node are obtained by tracking the movement of the optical sensor over the terrain. For example, in determining the coordinates of the point associated with sensor node 1, the optical sensor is moved from the reference location 234 along a path 236 to the location 238 where the sensor node 1 is deployed. While the optical sensor is moving from the reference location 234 to the location 238, overlapping terrain images are taken along the path 236. As described in greater detail below, the terrain images are used to determine a coordinate location 238 of the sensor node 1. The coordinate location can be described in terms of longitude, latitude, and elevation, which collectively is denoted by a three-tuple (x, y, z). The three-tuple also corresponds to a vector 240 that represents the direction and distance sensor node 1 is from the reference location 234. The coordinate location of sensor node 1 is then programmed into sensor node 1.

The coordinate locations of the next five sensor nodes are determined in series by following the paths 242-246. Along each path a series of overlapping terrain images are captured and used to determine the coordinate location of each node. For example, once the coordinate location of sensor node 1 is determined and programmed into sensor node 1, the optical sensor is moved along the path 242 to the deployment location of sensor node 2. While the optical sensor is being moved from sensor node 1 to sensor node 2, overlapping terrain images are captured. The overlapping terrain images are used to determine the coordinate location 248 of sensor node 2, and the coordinate location is programmed into sensor node 2. The coordinate locations of sensor nodes 3-6 are determined in a like manner by following paths 243-246.

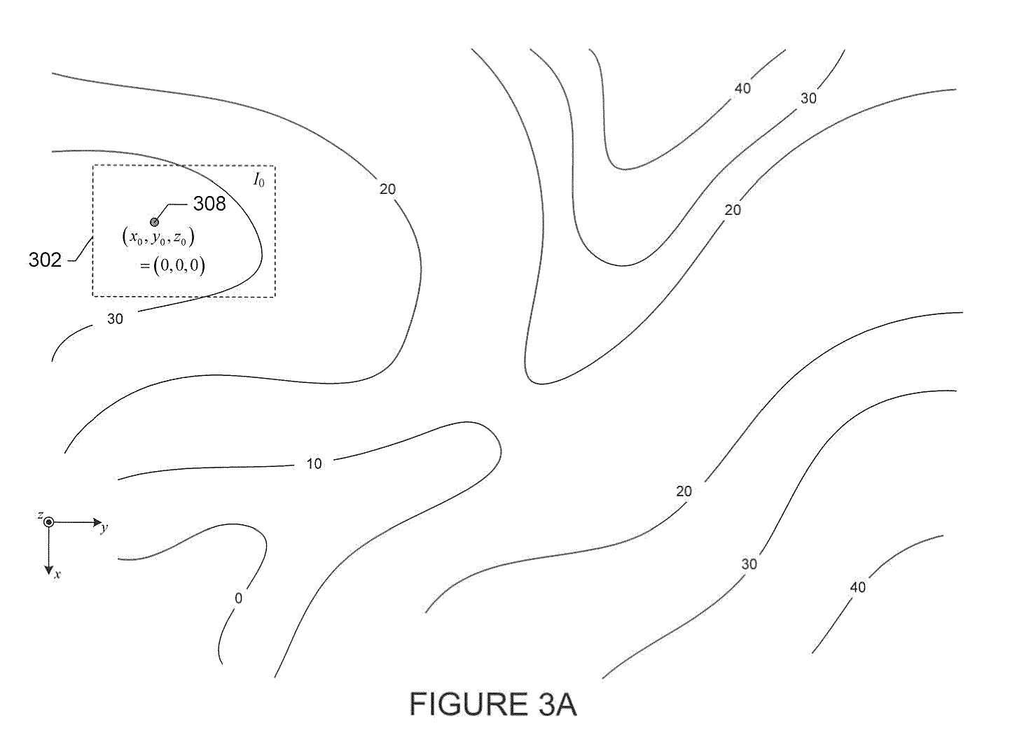

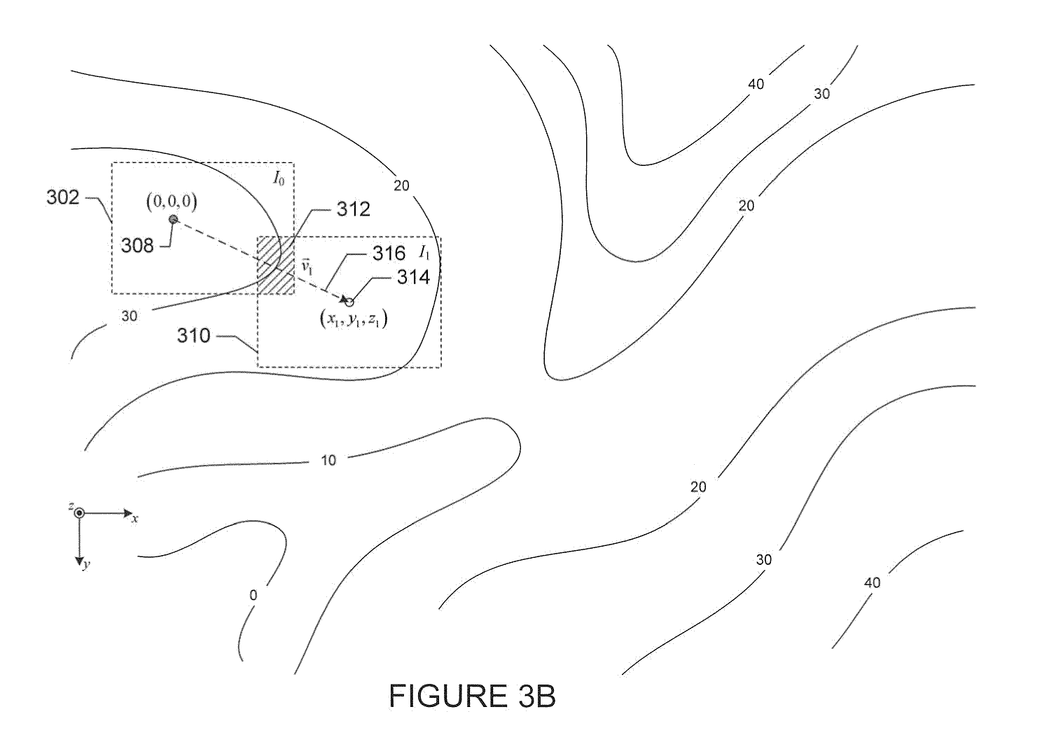

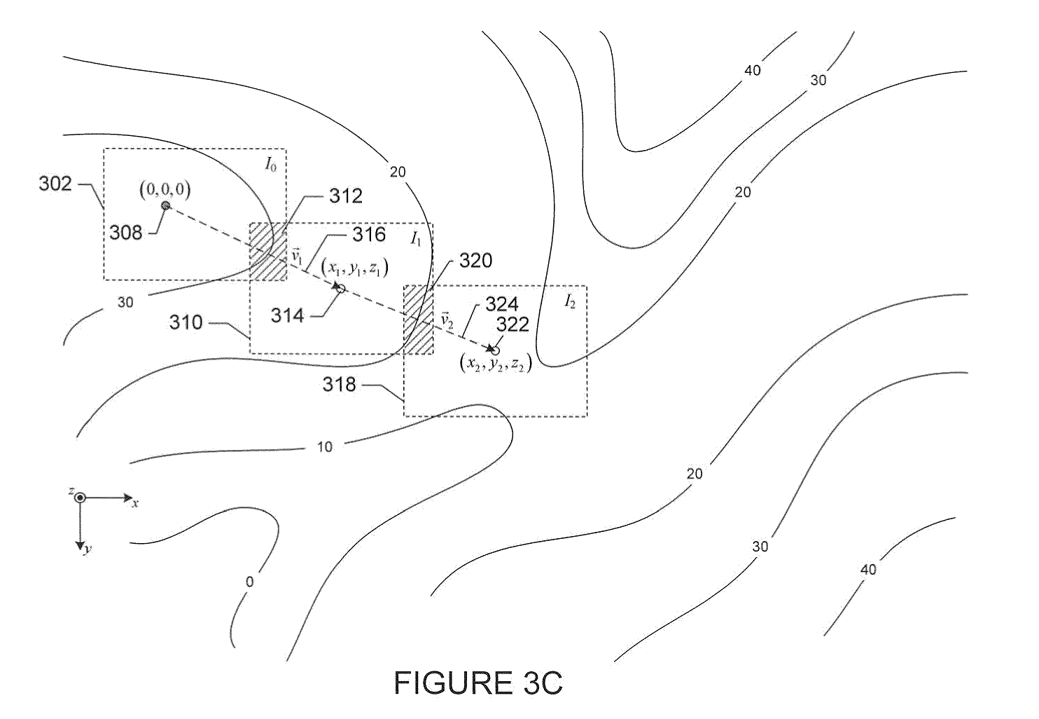

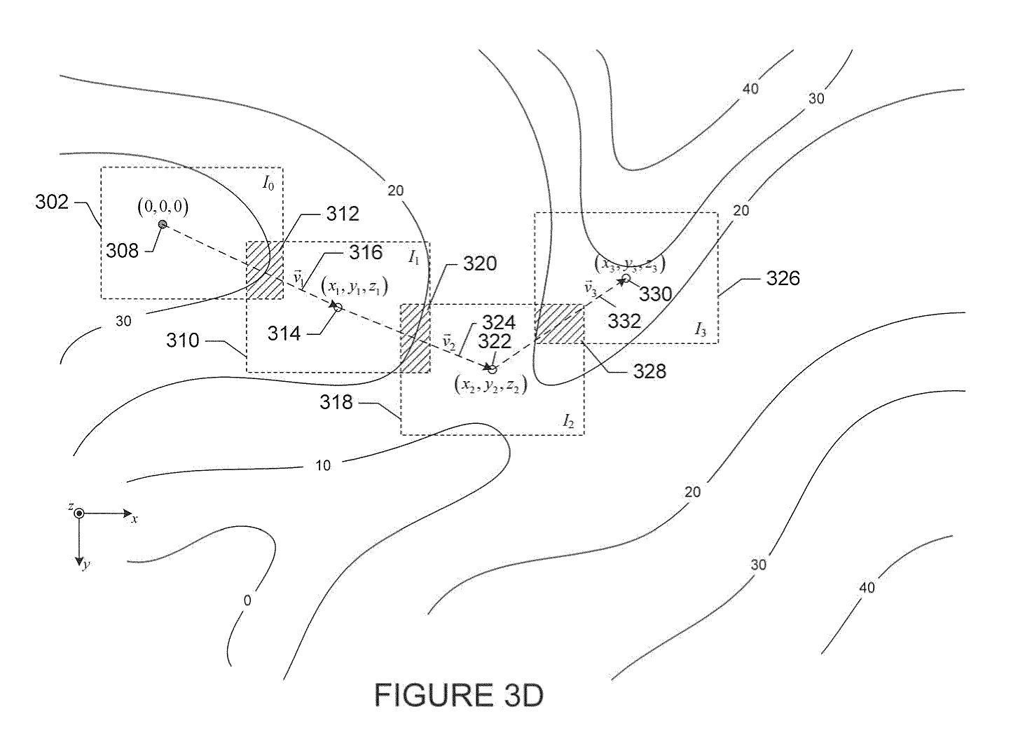

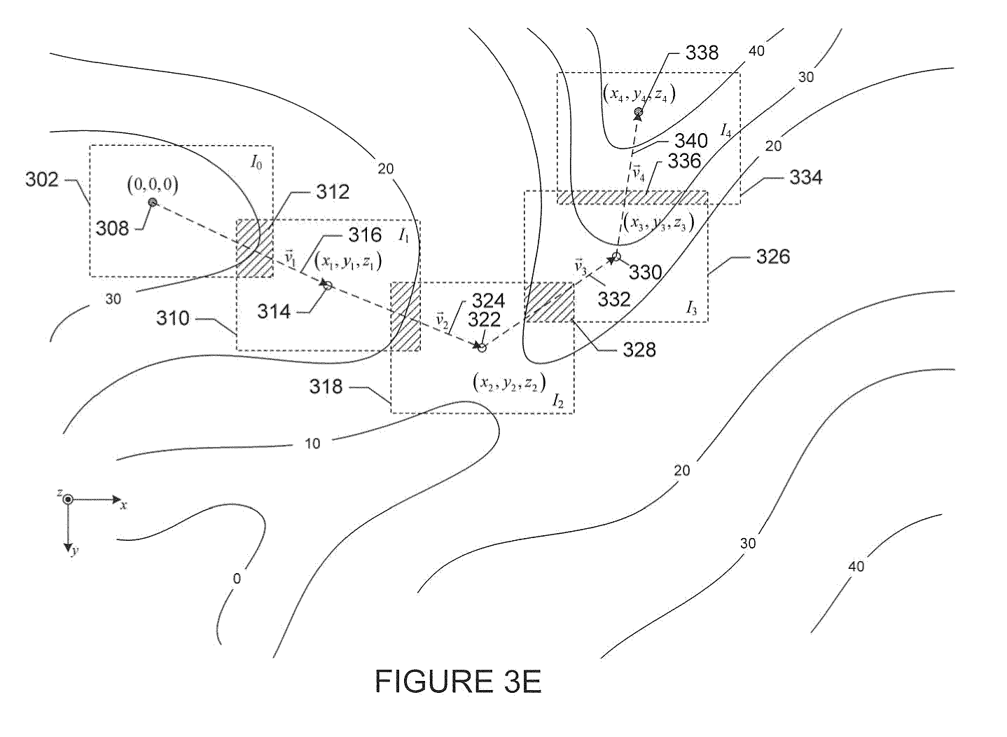

FIGS. 3A-3F show an example series of terrain images captured by an optical sensor as the optical sensor is moved from a reference location to a first sensor node location. As shown in the example of FIGS. 3A-3F, terrain images of the landscape are represented by dashed line rectangles, such as dashed-line rectangle 302 shown in FIG. 3A, and are obtained by pointing the lens 214 at the ground. The landscape over which the terrain images are captured is represented by a topographic map.

At the beginning of deploying a grid of sensor nodes, a reference location 308 is identified and a terrain image I₀ of the reference location is captured using the optical sensor. The longitude and latitude coordinates of the reference location 308, identified as x₀ and y₀, can be obtained using a global positioning system (“GPS”). The GPS coordinates (x₀,y₀) of the reference location are entered into the optical sensor 200 or computing device 218, and the point within the terrain image corresponding to the reference location (x₀,y₀) is identified. In certain embodiments, the display 216 can be a touch screen and the operator can identify the reference location (x₀,y₀) in the image by touching the point on the display that corresponds to the reference location (x₀,y₀), or, in other embodiments, the operator can move a mouse cursor to the pixels associated with the reference location (x₀,y₀) and click the mouse button to identify the reference location in the terrain image.

However, GPS systems only identify the longitudinal and latitude coordinates and cannot determine elevation z. The elevation sensor 208 can include a system for measuring the air pressure P. Typically air pressure varies smoothly from the Earth's surface to the mesosphere. Although air pressure changes with weather conditions, barometric formulas that relate air pressure to elevation z have been determined and average air pressure versus elevation for many places around the Earth have been tabulated. Barometric formulas or tabulated elevations and pressures can be used to determine the elevation z as follows.

In certain embodiments, based on the measured air pressure P, the elevation z can be calculated using a barometric formula. For example, given the air pressure P, an approximate elevation z at any location between mean sea level and 11,000 meters (36,089 feet) can be determined using

$$z = \frac{{T}_{b}}{{L}_{b}} [ {( \frac{P}{{P}_{b}} )}^{\frac{- {R}^{*} {L}_{b}}{{g}_{0} M}} - 1 ]$$

where
T_{b} is the standard temperature (K),
L_{b} is the standard temperature lapse (K/m),
P_{b} is static pressure (Pa),
R* is the universal gas constant (8.31432 J/K mol),
g₀ is standard gravity (9.8 m/s²), and
M is the molar mass of air (0.0289644 kg/mol).

In other embodiments, the elevation z can be calculated by interpolating a polynomial approximation of the elevation as a function of air pressure where the data points used to construct a polynomial approximation are based on tabulated pressure and elevation data. An example portion of a look-up table that can be used to interpolate an approximate elevation is given in Table I:

TABLE I

| | | Absolute | Absolute |
|---|---|---|---|
| Elevation above sea | | barometer | atmospheric pressure |
| level | | (mm Hg) | (kPa) |
| 0 ft | 153 m | 760.0 | 101.33 |
| 500 ft | 305 m | 746.3 | 99.49 |
| 1,000 ft | 458 m | 733.0 | 97.63 |
| 1,500 ft | 610 m | 719.6 | 95.91 |
| 2,000 ft | 763 m | 706.6 | 94.19 |

Note that in order to obtain an accurate elevation z, the elevation z corresponds to the elevation of the optical sensor when the terrain image is captured minus the height of the optical sensor above the ground.

Returning to FIG. 3A, the GPS coordinates (x₀,y₀) and the elevation z₀ at the reference location 308 are stored as a three-tuple (x₀, y₀, z₀) and correspond to the origin (0, 0, 0) of the sensor network.

Once the reference location coordinates have been determined, the grid layer can begin moving to a desired location at which a sensor node is to be placed. The optical sensor 200 begins capturing overlapping images of the landscape terrain as the grid layer moves. FIG. 3B shows a first terrain image I₁ 310 captured after the grid layer begins to move. Image autocorrelation is used to determine the image 302 and image 310 intersection I₀∩I₁ represented by shaded region 312. Next, a point (x₁,y₁) within the image 310 is selected and the elevation z₁ is determined using the elevation sensor 210 in order to form a three-tuple (x₁, y₁, z₁) 314 associated with the image I_{I}. A vector 316 \vec{v}₁ extending from the reference location 308 to the point 314 is determined using the general expression

\vec{v}ᵢ=(xᵢ,yᵢ,zᵢ)−(xᵢ₋₁,yᵢ₋₁,zᵢ₋₁)

where (x₀, y₀, z₀)=(0, 0, 0).

FIG. 3C shows a third terrain image I₂ 318 captured while the grid layer is moving down hill. The image 318 overlaps the image 310 and image autocorrelation is used to determine the image 310 and the mage 318 intersection I₁∩I₂ represented by shaded region 320. A point (x₂,y₂) within the image 318 is selected and the elevation z₂ is determined in order to obtain a three-tuple (x₂, y₂, z₂) 322. A vector 324 \vec{v}₂ extending from the point 314 to the point 322 is determined.

FIG. 3D shows a fourth terrain image I₃ 326 captured while the grid layer is moving up hill. Image autocorrelation is used to determine where the image 326 and image 318 intersection I₂∩I₃ represented by shaded region 328. A point (x₃,y₃) within the image 326 is selected and the elevation z₃ is determined in order to obtain a three-tuple (x₃, y₃, z₃) 330. A vector 332 \vec{v}₃ extending from the point 314 to the point 330 is determined.

FIG. 3E shows a fifth terrain image I₄ 334 captured after a sensor node location (x₄,y₄) has been identified. The operator places the sensor node and captures the image 334, which intersects with the image 326 as represented by shaded region 336. The operator of the optical sensor can identify the location (x₄,y₄) of the sensor node in the terrain image 334 as described above. The display 216 can be a touch screen and the operator can identify the sensor node location (x₄,y₄) in the image 334 by touching the point on the display that correspond to the location (x₄,y₄), or the operator can move a mouse cursor to the pixels associated with the location (x₄,y₄) and click the mouse button to identify the sensor node location. The elevation z₄ is determined and a three-tuple (x₄, y₄, z₄) 338 corresponding to the sensor node location is obtained. A vector 340 \vec{v}₃ extending from the point 330 to the point 338 is determined.

The coordinate location of the next sensor node to be deployed is determined by tracking the terrain images as described above with reference to FIGS. 3B-3E beginning with the terrain image I₄ 334.

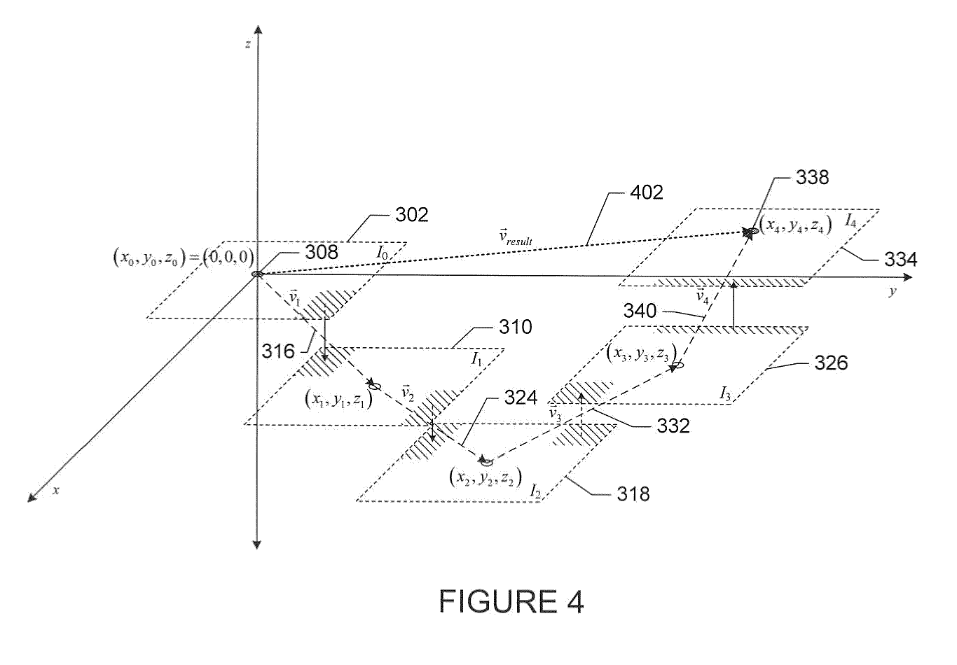

FIG. 4 shows the images 302, 310, 318, 326, 334 displayed in three-dimensional space. Each image corresponds to a different elevation in the landscape represented by the topographic map shown in FIGS. 3A-3E. FIG. 4 includes a resultant vector \vec{v}ᵣₑₛᵤₗₜ extending from the origin 308 to the sensor node location 338. The resultant vector can be obtained by summing terrain image vectors

$${\vec{v}}_{result} = {\sum }_{i = 0}^{4} {\vec{v}}_{i} .$$

The resultant vector \vec{v}result represents the direction and distance of the sensor node from the origin. The coordinates of the resultant vector associated with the sensor node are programmed into the sensor node.

The elevation at each point of the terrain images Iᵢ can be determined by taking an air pressure measurement followed by calculating the elevation using a barometric formula, or by interpolating a polynomial approximation of the elevation as function of air pressure based on tabulated data, the polynomial approximation can be used to calculate the elevation for a particular measured air pressure. In other embodiments, the elevation sensor 210 can be configured to detect changes in the orientation of the optical sensor as the optical sensor is moved. These changes can then be used to approximate the elevation.

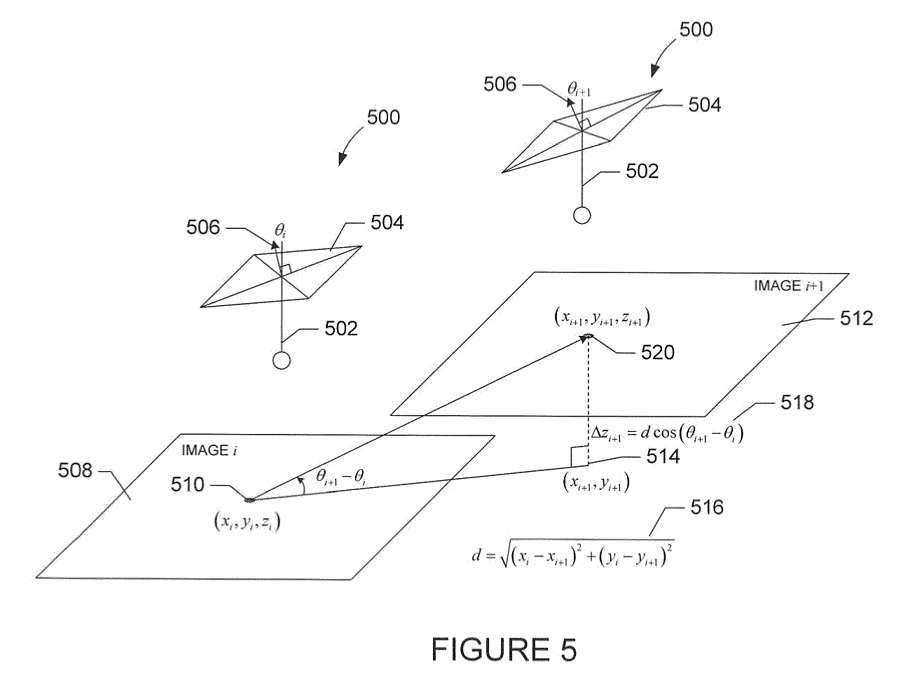

FIG. 5 shows a schematic representation of an example pendulum system 500 that can be used to determine the elevation between two successive terrain images in a series of terrain images. The pendulum system 500 is schematically represented by a pendulum 502 and a plane 504 with a corresponding normal vector 506. The orientation of the plane 504 corresponds to the orientation of the optical sensor as the optical sensor is moved from one terrain image to the next. As the optical sensor changes position while move moving over the terrain of a landscape, the pendulum remains substantially vertical. In other words, the pendulum 502 is allowed to pivot independent of the orientation of the plane 504. A change in the angle between the pendulum 502 and the normal vector 506 corresponds to a change in the angle of the optical sensor and can be used to determine a change in elevation between two consecutive terrain images. For example, as shown in FIG. 5, suppose that when terrain image i 508 is captured the angle between the pendulum 502 and the normal 506 is measured at θᵢ, and the coordinates of a point (xᵢ, yᵢ, zᵢ) 510 are known. Now suppose that as the grid layer is moved a new terrain image i+1 512 is captured, which overlaps the image i 508. The longitude and latitude coordinates (xᵢ₊₁,yᵢ₊₁) 514 are determined as described above. When the terrain image i+1 512 is taken, the angle between the pendulum 502 and the normal 506 is measured to be θᵢ₊₁. The distance 516 between the points (xᵢ,yᵢ) 510 and (xᵢ₊₁,yᵢ₊₁) 514 is calculated followed by calculating the change in elevation Δzᵢ₊₁ 518. The elevation associated with the point (xᵢ₊₁, yᵢ₊₁, zᵢ₊₁) 520 in the image i+1 512 is given by zᵢ₊₁=zᵢ+Δzᵢ₊₁.

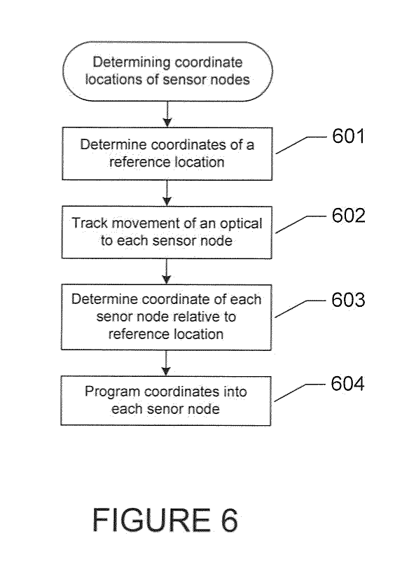

FIG. 6 shows a flow diagram summarizing determining coordinate locations of sensor nodes. In step 601, three-dimensional coordinates of a reference location in a terrain over which the sensor network is deployed are determined, as described above with reference to FIG. 3A. In step 602, beginning with the reference location, the movement of an optical sensor is tracked as the optical sensor moves from to each sensor node in series, as described above with reference to FIG. 2C. In step 603, a three-dimensional coordinate of each sensor node relative to the reference location is determined, based on data collected by the optical sensor, as described above with reference to FIGS. 3B-3E. In step 604, the three-dimensional coordinate associated with each sensor node is programmed into each sensor node.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for determining coordinate locations of sensor nodes associated with a sensor network, the method comprising:
determining three-dimensional coordinates of a reference location in a terrain over which the sensor network is deployed;
beginning with the reference location, tracking the movement of an optical sensor as the optical sensor moves to each sensor node in series;
determining a three-dimensional coordinate of each sensor node relative to the reference location based on data collected by the optical sensor; and
programming the three-dimensional coordinate into each sensor node.

2. The method of claim 1, wherein a three-dimensional coordinate further comprises longitude, latitude, and elevation.

3. The method of claim 1, wherein determining the three-dimensional coordinate of the reference location further comprises:
determining longitude and latitude coordinates of the reference location using a global positioning system; and
determining elevation of the reference location.

4. The method of claim 3, wherein determining the elevation of the reference location further comprises:
measuring air pressure near the reference location; and
computing the elevation based on the air pressure using a computing device.

5. The method of claim 1, wherein tracking the movement of the optical sensor further comprises:
capturing a series of overlapping terrain images using the optical sensor;
auto correlating pairs of consecutive terrain images, each pair of consecutive terrain images comprising a current terrain image and a previous terrain image; and
for each pair of consecutive terrain images,
selecting a point within the current terrain image, the point corresponding to a longitude and a latitude,
determining an elevation associated with the point, the longitude, latitude and elevation forming a three-tuple associated with the current terrain image, and
constructing a vector extending from the three-tuple in the current terrain image to a three tuple the previous terrain image.

6. The method of claim 5, wherein selecting the point further comprises using the midpoint of each image.

7. The method of claim 5, wherein selecting the point further comprises selecting a point a random.

8. The method of claim 5, wherein determining the elevation further comprises:
measuring air pressure near the reference location; and
computing the elevation based on the air pressure using the optical sensor.

9. The method of claim 5, wherein determining the elevation further comprises:
tracking the orientation of the optical sensor at each terrain image;
determining a change in orientation of the optical sensor associated with consecutive terrain images; and
computing the change in elevation between consecutive terrain images based on the change in orientation of the optical sensor.

10. An optical sensor comprising:
a photo sensor array;
a lens configured to focus light on to the photo sensor array;
a processor configured to receive and process image data from the photo sensor; and
a computer readable medium having instructions encoded thereon for enabling the processor to perform the operations of:
receive three-dimensional coordinates of a reference location in a terrain over which the sensor network is deployed;
beginning with the reference location, track the movement of an optical sensor as the optical sensor moves to each sensor node in series;
determine a three-dimensional coordinate of each sensor node relative t0 the reference location based on data collected by the optical sensor; and
program the three-dimensional coordinate into each sensor node.

11. The optical sensor of claim 10, wherein a three-dimensional coordinate further comprises longitude, latitude, and elevation.

12. The optical sensor of claim 10, wherein determine the three-dimensional coordinate of the reference location further comprises:
determine longitude and latitude coordinates of the reference location using a global positioning system; and
determine elevation of the reference location.

13. The optical sensor of claim 12, wherein determine the elevation of the reference location further comprises:
measure air pressure near the reference location; and
compute the elevation based on the air pressure using a computing device.

14. The optical sensor of claim 10, wherein track the movement of the optical sensor further comprises:
capture a series of overlapping terrain images using the optical sensor;
auto correlating pairs of consecutive terrain images, each pair of consecutive terrain images comprising a current terrain image and a previous terrain image; and
for each pair of consecutive terrain images,
select a point within the current terrain image, the point corresponding to a longitude and a latitude,
determine an elevation associated with the point, the longitude, latitude and elevation forming a three-tuple associated with the current terrain image, and
construct a vector extending from the three-tuple in the current terrain image to a three tuple the previous terrain image.

15. The optical sensor of claim 14, wherein select the point further comprises use the midpoint of each image.

16. The optical sensor of claim 14, wherein select the point further comprises select a point a random.

17. The optical sensor of claim 14, wherein determine the elevation further comprises:
measure air pressure near the reference location; and
compute the elevation based on the air pressure using the optical sensor.

18. The optical sensor of claim 14, wherein determine the elevation further comprises:
track the orientation of the optical sensor at each terrain image;
determine a change, in orientation of the optical sensor associated with consecutive terrain images; and
compute the change in elevation between consecutive terrain images based on the change in orientation of the optical sensor.

19. A hand-held optical sensor for determining coordinate locations of sensor nodes of a sensor network, the optical sensor configured in accordance with claim 10.

20. A grid layer comprising:
a vehicle; and
an optical sensor connected to the vehicle, the optical sensor configured in accordance with claim 10.
